(19) United States
(12) Patent Application Publication
(10) Pub. No.: US 2005/0102208 A1
(43) Pub. Date: May 12, 2005

(54) Systems and methods for tracking financial securities transactions

(76) Inventors: Jerome Edward Gudgeon, Redhill (GB); Christopher David Jones, Guildford (GB)

Correspondence Address: Stephen T. Scherrer;McDermott, Will & Emery, 227 West Monroe, Chicago, IL, 60606-5096, US

(21) Appl. No.: 10/704,994

(22) Filed: Nov. 10, 2003

(51) Int. Cl. G06F 17/60

(52) U.S. Cl. 705/35; 705/36; 705/39

(57) ABSTRACT

Systems and methods for tracking financial securities transactions are provided. More specifically, price histories for one or more financial securities are graphically represented using a visual display interconnected with a computer. Indicators are provided on the graphical representation of the one or more securities indicating an action done to the financial security or securities at a point in time. By activating an indicator, information is communicated to the user relating to the action done to the financial security or securities.

### TECHNICAL FIELD

Systems and methods for tracking financial securities transactions are provided. More specifically, price histories for one or more financial securities are graphically represented using a visual display interconnected with an electronic computing device. Indicators are provided on the graphical representation of the one or more securities indicating an action done to the financial security or securities at a point in time. By activating an indicator, information is communicated to the user relating to the action done to the financial security or securities.

### BACKGROUND

Financial securities generally provide written evidence of ownership or creditorship, such as, for example, stocks or bonds, and may be traded on markets. Typically, price histories for financial securities may be tracked and are conventionally displayed as timeline charts graphed as price versus time. For example, a financial security may be traded in a market, such as, for example, the New York Stock Exchange, which provides an arena for a financial security to be bought and sold. The price of a financial security typically fluctuates over time depending on the supply and/or demand of the financial security. The fluctuation can be shown on the price history timeline chart.

Shareholders having portfolios of financial securities can typically track the status of their securities by reviewing records. These records typically consist of tables having information on the shareholder's securities, as well as transaction information. Transaction information may include information such as, for example, the price of the financial security when bought or sold, or other information, such as stock splits, dividends, and other like information. The information can be communicated to the shareholder or agent of the shareholder.

However, it is difficult to reconcile price history information relating to a particular financial security or common group of securities, such as a fund or the like, with information relating to a shareholder's transaction information. For example, price histories are typically provided in graph form, as a graph of price versus time, as noted above. However, transaction information relating to particular securities in an individual's portfolio is typically provided in tabular form. Therefore, it is difficult to see the relationship of the price history of the particular financial security or securities with the transaction information for a shareholder of the particular financial security.

A need exists, therefore, for systems and methods that relate price history information for a particular security or securities with transaction information or other information regarding actions relating to a particular security or securities in an shareholder's financial security portfolio. More specifically, a need exists for a graphical representation of both price history information and transaction information of the security or securities at discrete times over the price history of the security or securities.

### SUMMARY

Systems and methods for tracking financial securities transactions are therefore provided. More specifically, price histories for one or more financial securities are graphically represented using a visual display interconnected with an electronic computing device. Indicators are provided on the graphical representation of the one or more securities indicating an action done to the financial security or securities at a point in time. By activating an indicator, information is communicated relating to the action done to the financial security or securities.

To this end, in one example, a system is provided for showing financial security transaction information graphically comprising a financial security, a graphical representation of the price history of the financial security, and at least one indicator on the graphical representation of the price history of the financial security wherein the indicator represents an action relating to said financial security. Activating the indicator provides information relating to the action. Customer-specific actions, such as buy or sell actions committed by the customer or shareholder may be provided when the indicator is activated. In addition, other actions may be represented, such as corporate-specific actions, such as, for example, dividends or stock splits, or other like corporate actions that relate to financial securities. Moreover, customer-specific information relating to the corporate actions may be provided, such as how the corporate action affects the shareholder's holdings.

In addition, activating the indicator provides visual information relating to the action. For example, the visual information may be textual. Alternatively, the indicator provides audible information relating to the action.

Further, in the example, the graphical representation is provided by an electronic computing device on a visual display device. Activating the indicator comprises moving a cursor over the indicator on the visual display device. Information relating to the action appears on the visual display device when the indicator is activated. Moreover, a second indicator representing a second action relating to the financial security may be provided wherein activating the second indicator provides information relating to the second action.

In an alternate example, a method for providing graphical financial security transaction information comprises the steps of providing a financial security having a price history, representing the price history of the financial security graphically, representing an action relating to the financial security with a indicator on the graphical representation of the financial security, activating the indicator, and providing information relating to the action when the indicator is activated. The action represented by the indicator is a transaction relating to the financial security, such as, for example, a sale of the financial security. The method includes the step of providing information relating to the action when the indicator is activated. For example, the information may be textual. Alternatively, the method includes the step of providing aural information relating to the action when the indicator is activated.

The method further comprises the step of graphically representing the price history of the financial security on a visual display device of an electronic computing device. In addition, the method comprises the steps of providing a cursor on the visual display device of the electronic computing device and moving the cursor over the indicator on the visual display device to activate the indicator. Information relating to the action is provided when the indicator is activated. In addition, the method further comprises the steps of representing a second action relating to the financial security with a second indicator, activating the second indicator, and providing information relating to the second action when the second indicator is activated.

### BRIEF DESCRIPTION OF THE DRAWINGS

FIG. 1 illustrates a graphical representation of a price history with activated indicator in an embodiment of the present invention.

### DETAILED DESCRIPTION

Systems and methods for tracking financial securities transactions are provided. More specifically, price histories for one or more financial securities are graphically represented using a visual display interconnected with an electronic computing device. Indicators are provided on the graphical representation of the one or more securities indicating an action done to the financial security or securities at a point in time. By activating an indicator, information is communicated to the user relating to the action done to the financial security or securities.

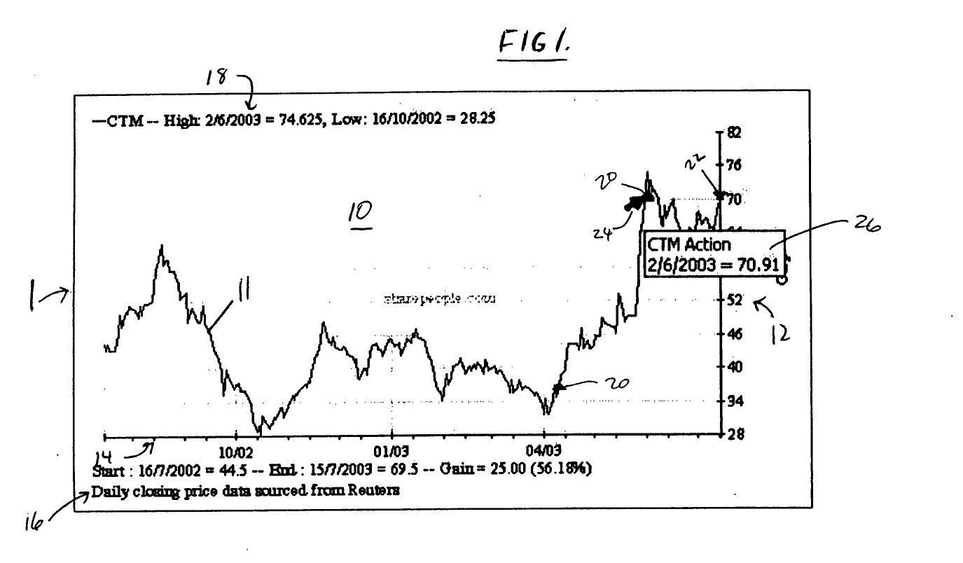

Referring now to the drawing, wherein like numerals refer to like parts, FIG. 1 illustrates a screen-shot 1 of a graphical representation 10 of a price history in the form of a plot-line 11 for a financial security that may be provided on a visual display device, such as a computer monitor or other like visual display device. Other visual display devices may include screens interconnected with any type of electronic computing device, such as a personal computer, a networked computer system, a hand-held computing device, a cellular telephone, or other like device. The graphical representation 10 illustrates a plot of prices 12 of the financial security over time 14. In the case illustrated in FIG. 1, the graphical representation 10 illustrates prices of the security from Jul. 16, 2002 to Jul. 15, 2003, thereby illustrating the price history of the financial security over a year period.

Under the graphical representation 10 is information 16 relating to the financial security over the year period, which provides information relating to the price of the financial security at the beginning of the year and at the end of the year, as well as the gain (or loss) in the value of the security over the period with a calculation of the percent gain (or loss). Of course, any other data relating to the security may be provided in the information 16.

Moreover, other information 18 may be provided. For example, the information 18 illustrated in FIG. 1 shows the historical high and low over the year period for the financial security. In this example, the high occurred on Jun. 2, 2003 and was 74.625. Moreover, the low occurred on Oct. 16, 2002, and was 28.25. Of course, any other data may be provided in the information 18.

Not only does the graphical representation provide general information relating to the price history of the financial security, it also gives individualized information regarding actions relating to a shareholder of the financial security. More specifically, tailored information relating to shareholder actions or corporate actions may be presented. For example, indicators may be provided that correspond to an action such as whether the financial security was bought or sold by the shareholder. In addition, other indicators may be provided that show actions relating to the financial security by other individuals or entities, such as corporate-specific actions.

For example, indicators may be associated with various location of the plot-line 11 at points in time where an action has occurred to the financial security, such as a stock split, a dividend, or other like action. However, the information presented may also be shareholder-specific, such as how a corporate action affects the shareholder's security value. For example, if there is a dividend relating to a specific stock, then the information presented by activating the indicator associated with that corporate action may provide the shareholder-specific information, such as the total amount of shares owned and the total value of the dividend based on the total amount of shares owned. In addition, if the corporate action is a stock split, then the shareholder-specific information may be provided when the indicator associated with the stock split is presented, such as the total number of shares affected by the stock split and the total number of shares held by the shareholder as a result of the stock split.

The indicator may be associated with the plot line 11 by being shown on the plot line 11 or near the plot-line 11. For example, an indicator may be represented in a location near the plot-line 11 and a reference line may connect the indicator with a particular point on the plot line 11. Of course, any other type of action may be represented by an indicator on or near the plot-line 11.

Referring to FIG. 1, “up” triangles 20 are shown in two different locations on the plot-line 11 of the price history of the financial security. The “up” triangles may illustrate a “buy” transaction, in which the shareholder buys shares of the financial security. A “down” triangle 22 is also shown, which may illustrate a “sell” transaction, in which the shareholder sells shares of the financial security. Of course, any other symbols may be used to illustrate the transactions that may occur with respect to the financial security. In addition, the indicators may be represented by colors. For example, the “buy” transaction may be represented by the color green. Moreover, the “sell” transaction may be represented by the color red. Of course, other colors may be utilized to illustrate any of the transactions that may be represented by the indicators.

Further information regarding the particular transactions shown by the indicators may be provided to an individual who is viewing the graphical representation 10 on a computer screen or other like visual display device. More specifically, typical visual display devices interconnected with, for example, personal computers, allow an individual to move a cursor or an arrow. The cursor or arrow may be interconnected with a control means, such as keys on a computer keyboard, a mouse, or other like control means. The cursor or arrow may be controlled so as to move over the indicators on the graphical representation 10. When the cursor or arrow moves over an indicator, the indicator may be activated thereby showing the individual information relating to the action represented by the indicator.

Alternatively, the graphical representation 10 may be presented on a visual display device that operates as a “touch screen”, whereby a user of the visual display device can physically touch the screen with a tool or a digit to cause the indicator to become activated.

For example, referring to FIG. 1, an arrow 24 controlled by a mouse may “hover” over one of the “up” triangles 20, which illustrates a “buy” action. When the arrow 24 “hovers” or otherwise contacts the “up” triangle 20, information relating to that action is shown in a “pop-up” text box 26. The “pop-up” text box 26 may automatically appear when the arrow 24 activates the “up” triangle 20 and may show specific information relating to the financial security, such as, for example, a date of the action and a price of the financial security at the time of the action. Moreover, other information may be provided, such as, for example, the amount of financial securities bought at that time. Any other information may be provided relating to the financial security. In addition, the indicator may be activated by “clicking” on the indicator with a mouse or other device.

Moreover, other ways of providing the information contained within the text box 26 may occur. For example, a tone or other audible signal may be generated by the electronic computing device when the cursor or arrow activates an indicator, thereby alerting the individual as to the action relating to the financial security. Moreover, more detailed information may be provided aurally as well when an indicator is activated by a cursor or arrow. For example, speech may be generated by the electronic computing device which audibly provides the information contained within the text box 26 when an indicator is activated.

The information contained within the text box 26, or otherwise provided symbolically or audibly, is tailored to the particular action committed to the financial security at the particular time relating to the shareholder of the financial security. In addition, other graphical representations may be shown of price histories of securities, including securities that may be grouped together in a fund or the like. The entire fund may be tracked by price and actions relating to the fund may be provided by indicators as described above. In addition, the information provided by the symbols may apply to a group of investors that have pooled their resources together for a particular financial security, securities, or fund.

The present invention has been described above with reference to exemplary embodiments. However, those skilled in the art having read this disclosure will recognize that changes and modifications may be made to the exemplary embodiments without departing from the scope of the present invention.

1. A system for providing financial security transaction information graphically comprising:
a financial security;
a graphical representation of the price history of the financial security;
at least one indicator associated with the graphical representation of the price history of the financial security, wherein the indicator represents an action relating to the financial security wherein activating the indicator provides information relating to the action.

2. The system of claim 1 wherein the action represented by the indicator is a transaction relating to the financial security.

3. The system of claim 2 wherein the transaction relates to a sale of the financial security.

4. The system of claim 1 wherein activating the indicator provides visual information relating to the action.

5. The system of claim 4 wherein the visual information is textual.

6. The system of claim 1 wherein activating the indicator provides audible information relating to the action.

7. The system of claim 1 wherein the graphical representation is provided by an electronic computing device on a visual display device.

8. The system of claim 7 wherein activating the indicator comprises moving a cursor over the indicator on the visual display device.

9. The system of claim 7 wherein said information relating to the action appears on the visual display device when the indicator is activated.

10. The system of claim 1 further comprising:
a second indicator representing a second action relating to the financial security wherein activating the second indicator provides information relating to the second action.

11. A method for providing financial security transaction information graphically comprising the steps of:
representing a price history of a financial security graphically;
representing an action relating to the financial security with an indicator associated with the graphical representation of the financial security;
activating the indicator; and
providing information relating to the action when the indicator is activated.

12. The method of claim 11 wherein the action represented by the indicator is a transaction relating to the financial security.

13. The method of claim 12 wherein the transaction relates to a sale of the financial security.

14. The method of claim 11 further comprising the step of:
providing information of the action when the indicator is activated.

15. The method of claim 14 wherein the visual information is textual.

16. The method of claim 11 further comprising the step of:
providing audible information of the action when the indicator is activated.

17. The method of claim 11 further comprising the step of:
graphically representing the price history of the financial security on a visual display device interconnected with an electronic computing device.

18. The method of claim 17 further comprising the steps of:
providing a cursor on the visual display device of the electronic computing device; and
moving a cursor over the indicator on the visual display device to activate the indicator.

19. The method of claim 17 further comprising the step of:
showing the information relating to the action on the visual display device when the indicator is activated.

20. The method of claim 11 further comprising the steps of:
representing a second action relating to the financial security with a second indicator;
activating the second indicator; and
providing informat
